(19) United States
(12) Patent Application Publication
(10) Pub. No.: US 2002/0145668 A1
(43) Pub. Date: Oct. 10, 2002

(54) Imaging apparatus for providing image in a resolution higher than is possible with a resolution provided numbers of physical pixels, and display apparatus for displaying image in a resolution same

(76) Inventor: Nozomu Harada, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/076,644

(22) Filed: Feb. 19, 2002

(30) Foreign Application Priority Data
Feb. 19, 2001 (JP) 2001-042374
Feb. 19, 2001 (JP) 2001-042375

(51) Int. Cl. H04N 3/14

(52) U.S. Cl. 348/219.1

(57) ABSTRACT

Setting so as to substantially minimize the aliasing distortion component at zero in spatial frequencies and at a Nyquist frequency is one of the examples of the present invention. When the setting is used, an image can be provided and displayed at a resolution higher than the number of physical pixels in the imaging apparatus and display apparatus.

### CROSS-REFERENCE TO RELATED APPLICATIONS

This application is based upon and claims the benefit of priority from the prior Japanese Patent Applications No. 2001-42374 and No. 2001-42375, both filed Feb. 19, 2001, the entire contents of which are incorporated herein by reference.

### BACKGROUND OF THE INVENTION

1. Field of the Invention

The present invention relates an imaging apparatus which can provide an image in a resolution higher than the number of physical pixels and a display apparatus which can display an image in the same resolution.

2. Description of the Related Art

In an imaging apparatus or a display apparatus, pixels (light-sensitive portions) are arranged one-dimensionally or two-dimensionally. In recent years, since the amount of information to be imaged or displayed has increased, the apparatus requires a higher resolution.

To realize a higher resolution in the imaging apparatus or display apparatus, it is necessary to improve the fine pitch in manufacturing processing. Due to the improvement of the fine pitch, the number of physical pixels per unit area is increased. However, to realize a higher resolution, in addition to the increase of the number of pixels, it is important to reduce false signals such as moire signals.

The present inventors have proposed imaging apparatuses in which a higher resolution can be realized (Japanese Patent Application No. 56-209381, Japanese Patent Application No. 58-107098, and Japanese Patent Application No. 59-14292 (Japanese Examined Patent Application Publication No. 1-35550)).

These proposals intend to relatively vibrate a solid state imaging device substrate in, for example, the horizontal array direction at an amplitude corresponding to ½ of a horizontal pixel pitch P_{H} to move spatial sampling points.

For example, when two fields constitute one frame (screen), the device substrate is relatively moved in the horizontal direction for a blanking period between the fields at an amplitude corresponding to ½ of the horizontal pixel pitch P_{H}. Signal charges photoelectrically converted at respective positions are read out for the blanking period between the fields. The read-out signal charges are signal-processed so as to match the actual spatial sampling points at entrance point and are then displayed by the display apparatus.

Since the spatial sampling points in the horizontal pixel direction included in the imaging device itself can be set to be about twice as much as the number of physical pixels, an effective horizontal resolution can be doubled. In the imaging apparatus, since the blanking period between the fields can be arbitrarily adjusted by setting a field period, the blanking period is not remarkably restricted due to relative movement.

The present inventors have confirmed the following fact. That is, when a trapezoidal waveform, a triangular waveform, or a sinusoidal waveform is used in addition to the rectangular waveform as a vibration waveform to relatively move the device substrate, a higher resolution can be similarly realized. Furthermore, when the device substrate is relatively moved by using a waveform obtained by applying a vibration of a rectangular waveform, a trapezoidal waveform, a triangular waveform, or a sinusoidal waveform to the rectangular waveform, an image having fewer false signals and a higher resolution is obtained.

FIG. 8A shows a plan view of a light-receiving surface (light-sensitive portions) of a solid state imaging device. The imaging device shown in FIG. 8A is, for example, an interline transfer type CCD.

FIG. 8B shows the relation between time to vibrate the light-sensitive portions (light-receiving surface) of the solid state imaging device shown in FIG. 8A and timing to read out signal charges from the light-sensitive portions of the solid state imaging device.

With reference to FIG. 8A, an example in which a device substrate on which the solid state imaging device is disposed is vibrated in the horizontal direction (an arrow P_{H}) will now be described.

A first vibration is a rectangular waveform vibration in which one frame is one cycle on condition that X₃ is at the center of the vibration and a distance between X₂ and X₄, namely, the amplitude corresponds to ½ of the horizontal pixel pitch P_{H}. A second vibration serving as a harmonic is superimposed on the vibration.

As shown in FIG. 8B, the center of the light-sensitive portion of the imaging device is vibrated between X₁ and X₃ in the A field and between X₃ and X₅ in the B field.

At switching points t₁ and t₃ in the A and B fields, a field shift pulse to transfer the signal charges accumulated in the light-sensitive portion to a reading section is generated. In other words, the signal charges accumulated for periods t₂ and t₄ are read out.

Consequently, the center of an aperture 2 in each pixel is vibrated (swung) between the positions X₁ and X₃ for the period t₂ in the A field, so that the aperture of the pixel is effectively enlarged. On the other hand, since the center of the aperture is vibrated (swung) between the positions X₃ and X₅ for the period t₄ in the B field, the aperture ratio of the pixel is effectively raised in the same way as the A field. When the period t₁ or t₃ is enough shorter than the period t₂ or t₄, it can be considered that the state is equivalent to such a state that the aperture 2 of the pixel is enlarged between X₃ and X₅ and is then set at rest for the period t₂ in the A field.

As mentioned above, when the device substrate is vibrated in the horizontal direction (arrow P_{H}), the number of spatial sampling points of the array in the horizontal pixel direction can be raised to the value that is twice as much as the actual number of pixels. The effective aperture ratio of the pixel aperture is also raised. Enlarging the pixel aperture is useful for the reduction of false signals such as moire due to an aliasing distortion which occurs in the imaging apparatus including pixels arranged one-dimensionally or two-dimensionally.

As mentioned above, the number of fields constituting one frame is increased and the solid state imaging device substrate is relatively moved synchronously with the individual field to increase the number of spatial sampling points, so that the effective resolution can be improved. A limit resolution of the imaging device is determined on the basis of a Nyquist frequency described in the sampling theorem.

However, even when the number of fields per frame is increased to increase the number of effective spatial sampling points, the Nyquist frequency of each field is determined on the basis of the number of pixels of the imaging device. Accordingly, an image signal of each field has a large aliasing distortion yet. Therefore, increasing the number of fields can improve the limit resolution in the sampling theorem. However, there is a problem that the substantial limit resolution cannot be improved unless image deterioration caused by an aliasing distortion output is eliminated.

### BRIEF SUMMARY OF THE INVENTION

An object of the present invention is to provide an imaging apparatus and a display apparatus, which can provide or display an image in a resolution higher than the number of physical pixels.

According to the present invention, there is provided an imaging apparatus comprising an imaging device having a plurality of light-sensitive portions arranged at least one-dimensionally or two-dimensionally, each light-sensitive portion including an arbitrary number of fields; and a position control section which moves the relative positions of image points and the respective light-sensitive portions of the imaging device every field, wherein an effective aperture ratio of the light-sensitive portion is set so as to substantially minimize an aliasing distortion component at zero of spatial frequencies and at a Nyquist frequency.

Further, according to the present invention, there is provided an imaging apparatus comprising an imaging device in which a plurality of light-sensitive portions are arranged at least one-dimensionally or two-dimensionally; and a position control section which moves the relative positions of image points and the respective light-sensitive portions of the imaging device in a frame comprising four or more even-numbered fields every field, wherein the fields are formed so that a spatial phase at the position of the light-sensitive portion shifts 180° between the adjacent fields.

Further, according to the present invention, there is provided a display apparatus comprising a display panel having a plurality of display pixels arranged at least one-dimensionally or two-dimensionally, each display pixel including an arbitrary number of fields; a screen to which an image on the display panel is projected; and a position control section which moves image points projected on the screen every field, wherein an effective image area ratio on the screen is set so as to substantially minimize an aliasing distortion component at zero of spatial frequencies and at a Nyquist frequency.

Further, according to the present invention, there is provided a display apparatus comprising a display panel having a plurality of display pixels arranged at least one-dimensionally or two-dimensionally, each display pixel including an arbitrary number of fields that is equal to or larger than four and is an even number; a screen to which an image on the display panel is projected; and a position control section which moves image points projected on the screen every field, wherein the fields are formed so that a spatial phase at the position of the display pixel shifts 180° between the adjacent fields.

Further, according to the present invention, there is provide an image processing method which can provide or display an image in a resolution, which is higher than the number of physical pixels provided by light-sensitive portions and display pixels, using an image processing section having at least one of an imaging apparatus including a plurality of light-sensitive portions and a display apparatus including a plurality of display pixels, and a position control section which displaces the relative positions of at least one pair of a pair of the light-sensitive portions of the image processing section and image points related to the respective light-sensitive portions, and a pair of the display pixels of the image processing section and projection image points related to the respective display pixels, the method comprising displacing the relative positions of at least one pair of the pair of the light-sensitive portions of the image processing section and the image points related to the respective light-sensitive portions and the pair of the display pixels of the image processing section and the projection image points related to the respective display pixels.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic plan view explaining an example of an pixel array of an interline transfer type CCD which can be used as an imaging device to which the present invention can be applied;

FIG. 2A is a schematic plan view explaining an example of a pixel array of the interline transfer type CCD shown in FIG. 1;

FIG. 2B is a schematic diagram explaining an example in which an embodiment according to the present invention is applied to the interline transfer type CCD shown in FIG. 1;

FIG. 3 is a schematic graph explaining MTF characteristics when an aperture ratio αx is changed in the embodiment according to the present invention, which is explained with reference to FIGS. 2A and 2B;

FIG. 4 is a schematic diagram explaining a change in MTF when the aperture ratio αx explained in FIG. 3 is set to 0.5;

FIG. 5A is a schematic plan view explaining an example of a pixel array of an interline transfer type CCD equivalent to the interline transfer type CCD shown in FIG. 2A;

FIG. 5B is a schematic diagram explaining a modification of the embodiment according to the present invention explained with reference to FIG. 2B;

FIG. 6 is a schematic graph showing conditions that an aliasing distortion can be set to zero at zero in spatial frequencies and at a Nyquist frequencies;

FIG. 7A is a schematic diagram explaining a case where the embodiment of the present invention described with reference to FIGS. 2A, 2B, 3 to 6 is applied to an imaging apparatus;

FIG. 7B is a schematic plan view explaining an example of a pixel array of an interline transfer type CCD equivalent to the interline transfer type CCD shown in FIG. 2A;

FIG. 7C is a schematic diagram explaining an example of timing when an image signal is acquired in each field similar to the embodiment of the present invention described with reference to FIG. 2B;

FIG. 8A is a plan view explaining an example of a light-sensitive portion of a well-known solid state imaging device; and

FIG. 8B is a schematic diagram explaining a well-known imaging method for providing an image using an interline transfer type CCD shown in FIG. 8A.

### DETAILED DESCRIPTION OF THE INVENTION

An embodiment of the present invention will now be described in detail hereinbelow with reference to the drawings. The embodiment (operating principle), which will be described hereinbelow, can be applied to both of an imaging apparatus and a display apparatus. Accordingly, for the embodiment, main portions will be described using the imaging apparatus as an example. Of course, a difference between the imaging apparatus and the display apparatus will be described as necessary.

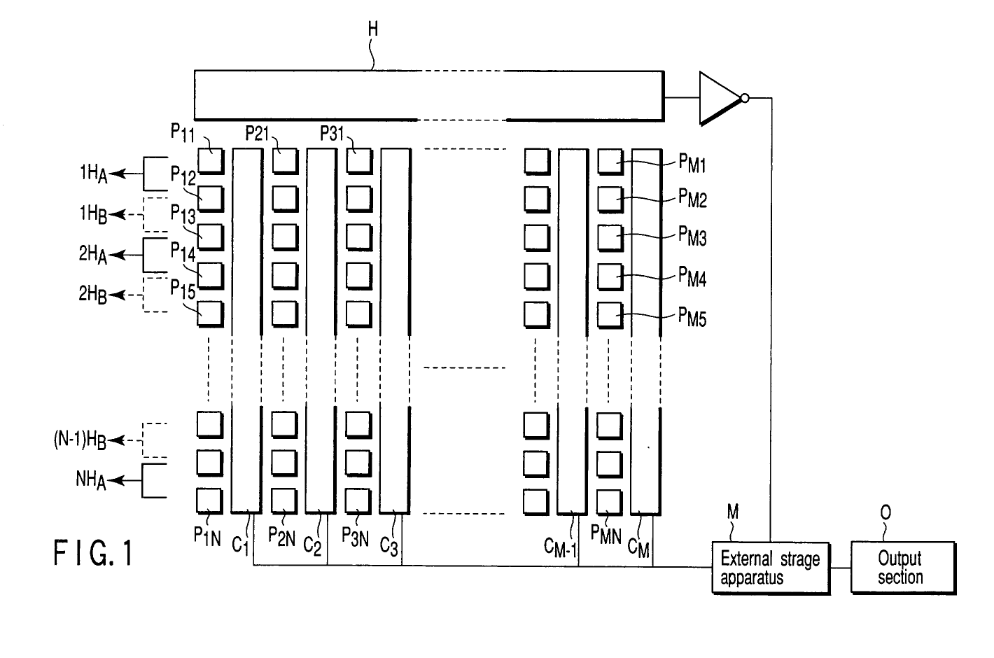

FIG. 1 is a schematic plan view explaining a case where an interline transfer type CCD is used as an imaging device and the embodiment of the present invention is applied to the imaging apparatus as an example.

The imaging apparatus shown in FIG. 1 has an imaging optical system (not shown), a CCD imaging device arranged via the imaging optical system, a position control section for moving the imaging device relatively with respect to an image point using, for example, a piezoelectric element, and a control circuit section for controlling the imaging device.

The imaging device comprises an interline transfer type CCD in which one frame includes four fields. The CCD and the image point, which will be explained in detail later, are moved relatively every field.

Moving the CCD and the image point every field precisely results in an increase in the number of spatial sampling points for the improvement of a limit resolution of the imaging device. The aperture ratio of each pixel of the CCD and the movement of the relative positions are set in response to a switching point of each field. Consequently, aliasing distortion in each field is reduced.

The imaging apparatus shown in FIG. 1 has, for example, an interline transfer type CCD including light-sensitive portions Pᵢⱼ (i=1, 2, . . . , M, j=1, 2, . . . , N) arranged in a two-dimensional (matrix) manner, vertical reading CCDs (registers) Cᵢ (i=1, 2, . . . , M), and a horizontal reading register H.

In the embodiment described hereinbelow, for the number of the light-sensitive portions of the CCD, for example, N is set to 500 and M is set to 800.

In the embodiment, to simplify the description, the interline transfer type CCD for monochrome images will be explained as an example. As a matter of course, when an interline transfer type CCD for color images is used, a color image can be provided.

The control circuit section has an external storage apparatus M including a frame memory for sequentially storing outputs from the vertical reading CCD registers Cᵢ and outputs of the horizontal reading register H, and an output section O for sequentially generating an output image signal (temporarily) stored in the external storage apparatus M to an image storage apparatus or an HDD (hard disk device) (not shown) on the basis of a control signal supplied from an external control section (not shown).

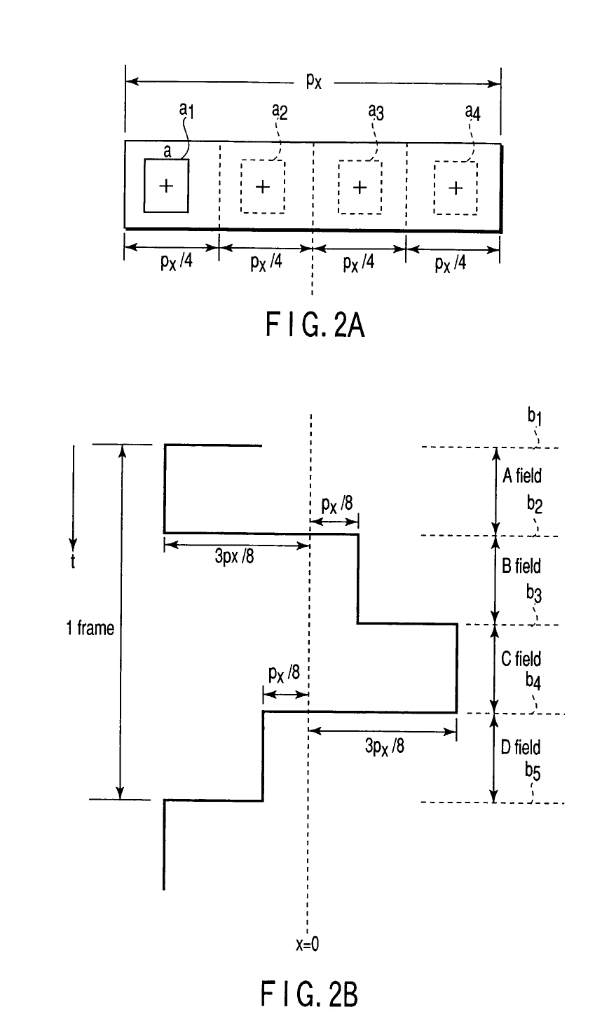

FIGS. 2A and 2B explain an example of the embodiment according to the present embodiment and show the relation between time when the respective pixels of the interline transfer type CCD shown in FIG. 1 are vibrated by the position control section and timing of a field shift pulse to read out signal charges from each light-sensitive portion of the solid state imaging device. FIG. 2A shows the constitution of the pixel serving as an object. FIG. 2B shows a waveform of a driving signal to move each pixel of the CCD for one frame cycle.

In this case, the realization of a higher horizontal resolution will now be described.

In FIG. 2A, the length of one pixel is set to Px and an aperture a₁ having a length a is formed in the pixel. The aperture a₁ corresponds to the light-sensitive portion. All the pixels formed on a substrate are controlled so as to perform the same operation by the position control section. In other words, in one frame including four fields, for blanking periods b₁, b₂, b₃, b₄, and b₅ between the fields, the substrate (not shown) holding the CCD is moved in the horizontal (Px) direction.

When it is assumed that the center of coordinates of the pixel is set to x, the center of the aperture is located at x=−3 Px/8 in an A field. Similarly, the center of aperture is located at x=Px/8 in a B field, is located at x=3 Px/8 in a C field, and is located at x=−Px/8. Hereinbelow, for the blanking period between the fields, the signal charges accumulated in each light-sensitive portion are read out and are then transferred to a reading section.

Since the reading and transfer operation is simultaneously performed to all the pixels, as shown in FIG. 2A, the apertures of all the pixels are formed in such a manner that the aperture a₁ is formed in the A field, an aperture a₃ is formed in the B field, an aperture a₄ is formed in the C field, and an aperture a₂ is formed in the D field.

When the above-mentioned operation is repeated in order to form one screen (frame) using four fields, pixel sampling points defined by the apertures al, a₂, a₃, and a₄ are formed in one pixel. Consequently, an image having a high resolution that is about four times as high as the numbers of physical pixels.

In the above-mentioned embodiment, for the apertures of the adjacent fields, as shown in FIG. 2B, a spatial phase, in which the pixel length Px is one cycle, shifts 180° between the apertures a₁ and a₃ of the A and B fields and between the apertures a₄ and a₂ of the C and D fields.

As mentioned above, an image is provided in one aperture in each field in the pixel length Px. Accordingly, the image includes aliasing distortions defined by the respective positions of the apertures.

However, when the positions of the apertures of the adjacent fields are shifted from each other by 180° with respect to the spatial phase, the individual aliasing distortions can cancel out each other sufficiently.

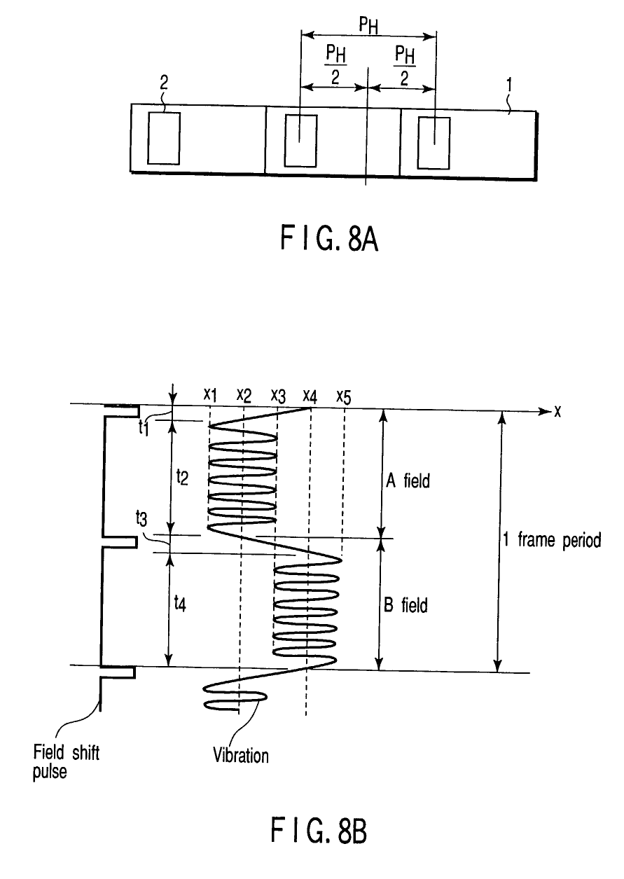

Consequently, the aliasing distortions can cancel out each other for a period that is half a frame cycle. As described with reference to FIGS. 8A and 8B, compared with the well-known case where the number of pixel sampling points is doubled, a cycle to cancel can be reduced to half.

Therefore, the aliasing distortions generated due to a change in time on the side of, particularly, a subject can be suppressed.

It is a characteristic point of the above-mentioned embodiment that the aperture ratio αx (α=a/Px) of each pixel is equal to 0.5. As will be described later, when the aperture ratio is set to 0.5, the aliasing distortion of each field can be reduced enough.

In the above-mentioned embodiment, the example in which one frame includes four fields has been described. It is needless to say that when the number of fields is an even number such as six or eight, any effect is not influenced by the number of fields. The reason can be described by the following fact. When the spatial phase shifts 180° between the fields, which are close to each other sufficiently in time, (with respect to the adjacent fields), the aliasing distortions can cancel out each other effectively.

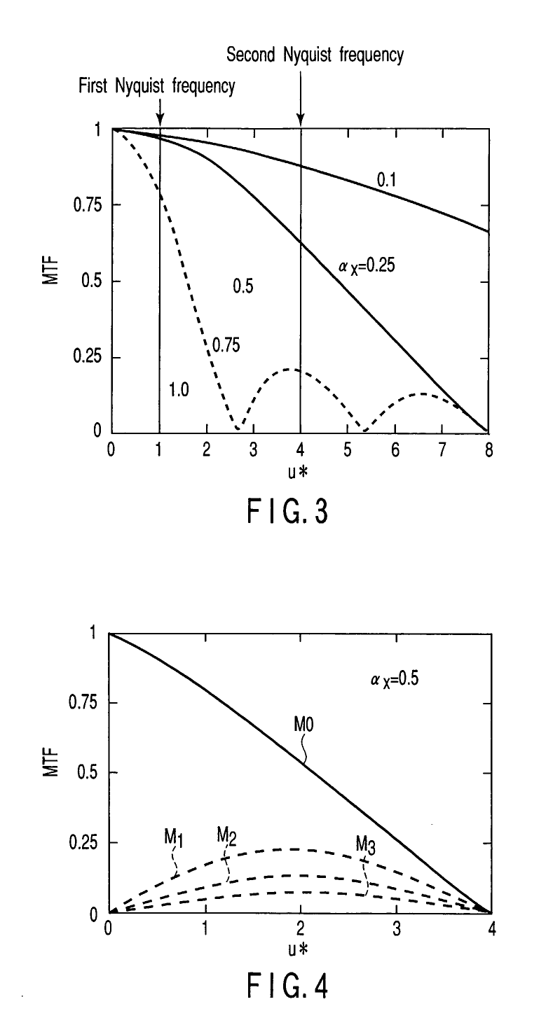

With reference to FIGS. 3 and 4, the resolution characteristics and the aliasing distortion characteristics of the imaging apparatus described with reference to FIGS. 2A and 2B will now be described in detail. To describe the resolution characteristics, MTF is used. In FIGS. 3 and 4, the MTF represents the modulation transfer function of an output when the imaging apparatus provides an image of a black and white bar pattern whose density is changed sinusoidally.

FIG. 3 shows MTF characteristics when the pixel aperture ratio αx is changed. Reference symbol u* denotes a spatial frequency standardized by a Nyquist frequency in a case where the higher-resolution realizing operation to move the imaging device substrate as the embodiment of the present invention is not performed. Accordingly, when u*=1, u* denotes a Nyquist frequency (first Nyquist frequency) which is not accompanied with the higher resolution. When u*=4, u* denotes a Nyquist frequency (second Nyquist frequency) in the imaging device substrate according to the present embodiment, in which four pixel sampling points are formed in one pixel.

An image having a spatial frequency component of the Nyquist frequency can be reproduced using the sampling theorem. A frequency component higher than the Nyquist frequency (exceeding the Nyquist frequency) is turned on the low frequency side of the Nyquist frequency. The turned output becomes a moire phenomenon, caused when a fine image is provided, or a false signal, observed at a pattern edge where contrast changes sharply, and is called an aliasing distortion.

When the fields are individually observed, the respective Nyquist frequencies denote u*=1. The amplitude of the MTF becomes large at the Nyquist frequency. In other words, it is understood that an image having a large aliasing distortion is provided in each field.

Therefore, according to the embodiment of the present invention, as mentioned above, the pixel apertures, which differ in spatial phase by 180°, are formed in the adjacent fields to cancel out the aliasing distortions of the adjacent fields each other.

In the above-mentioned embodiment of the present invention, four fields constitute one frame and the aperture ratio αx is set to 0.5 (αx=0.5), whereby the aliasing distortions at zero [0] of the spatial frequencies and at the Nyquist frequency (at two positions) can be suppressed to substantially zero [0] (predetermined level). Consequently, an image having less aliasing distortion and a higher resolution can be obtained over a wide spatial frequency range.

FIG. 4 shows aliasing distortion characteristics in the imaging apparatus according to the present invention and is a schematic graph explaining a change in MTF when the aperture ratio αx described in FIG. 3 is equal to 0.5 (αx=0.5).

In FIG. 4, reference symbol MO represents the MTF within the Nyquist frequency. For images in this region, an original signal can be reproduced or displayed faithfully. Reference symbols M₁, M₂, and M₃ denote spatial frequency depending properties of the aliasing distortions.

Reference symbol M₁ denotes characteristics of the aliasing distortion of 4<u*<8.

Reference symbol M₂ denotes characteristics of the aliasing distortion of 8<u*<12.

Reference symbol M₃ denotes characteristics of the aliasing distortion of 12<u*<16.

As obviously understood from the above, for all of the aliasing distortions in the high frequency region, each output denotes zero when u*=0 and u*=4. Even in a higher frequency region, the similar result is obtained.

Since the eyesight of a human being is high in the vicinity of u*=0, he or she can easily view the aliasing distortion. However, when circuit gain is reduced in order to reduce the aliasing distortion, the output of a signal itself is degraded, so that the resolution is degraded. Since the aliasing distortion generating in the vicinity of the Nyquist frequency interferes with the determination of an image in the vicinity of the limit resolution, the resolution is degraded.

On the other hand, according to the above-mentioned embodiment of the present invention, an image having a less aliasing distortion and a higher resolution can be obtained.

As mentioned above, when the embodiment of the present invention is applied to the imaging apparatus, four fields constitute one frame and the positions of the apertures of the adjacent fields are shifted from each other with respect to the spatial phase by 180°, so that the number of spatial sampling points can be raised to be four times as high as the number of physical pixels. In the foregoing constitution, the aliasing distortions of the adjacent fields can cancel out each other sufficiently. Since one frame is constituted of four fields and the aperture ratio αx (α=a/Px) of each pixel is set to 0.5, the MTF at zero of the spatial frequencies (u*=0) and at the Nyquist frequency (u*=4) can be set to substantially zero.

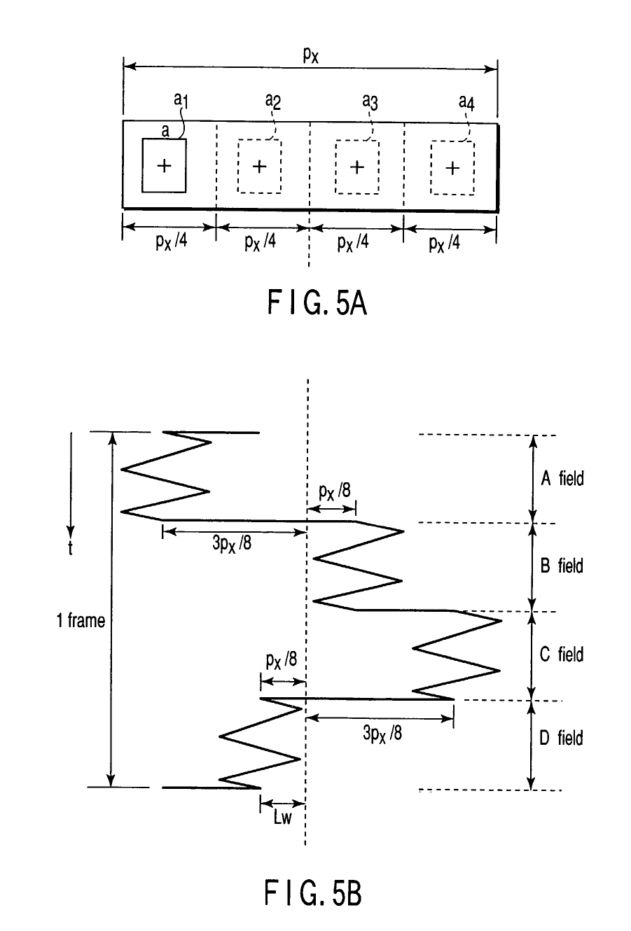

Another embodiment of the present invention will now be described with reference to FIGS. 5A and 5B.

In the above-mentioned embodiment shown in FIGS. 2A and 2B, only when the aperture ratio αx is equal to 0.5 (αx=0.5), the aliasing distortions at u*=0 and u*=4 can be set to 0. However, for an imaging apparatus having a high pixel density, it can be easily considered that the aperture ratio αx cannot be set to 0.5 (αx=0.5) from a manufacturing viewpoint. For this problem, it is also considered that an effective aperture ratio is raised using, for example, a micro lens array.

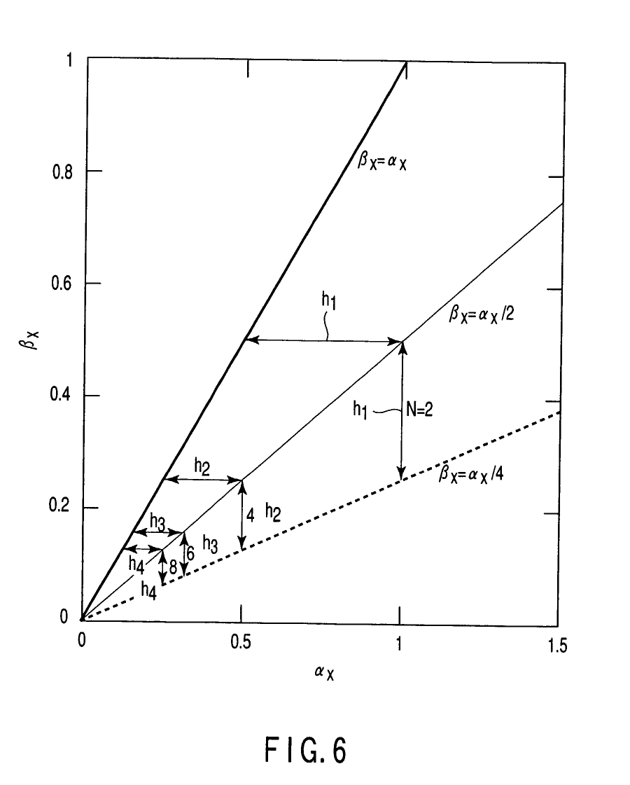

According to the embodiment shown FIGS. 5A and 5B, triangular wave vibration is applied to the device substrate for each field period to control the effective aperture ratio. According to such a method, an image having a less aliasing distortion and a higher resolution can be obtained. When the aperture shape (aperture length: a) and a triangular vibration amplitude 2 Lw are changed as will be described hereinbelow as an example with reference to FIG. 6, it is possible to satisfy conditions that an image having a less aliasing distortion and a higher resolution can be obtained. That is, the number of pixel sampling points can be increased and the resolution of the image can be easily raised.

FIG. 6 shows conditions that the aliasing distortion can be equal to zero [0] at zero of the spatial frequencies and at the Nyquist frequency.

Reference symbol βx (=a/Lw) denotes a vibration amplitude ratio. Reference numeral N denotes an even number of 2, 4, 6, . . . , or the like. When N=2, it denotes a case of the conventional high-resolution imaging apparatus explained above with reference to FIGS. 8A and 8B. The case corresponds to a case where two apertures are formed in one pixel.

As obviously understood from FIG. 6, an aliasing distortion output can be set to zero at two points of zero of the spatial frequencies and the Nyquist frequency under two conditions of h₁ and r₁.

The condition h₁ represents that even when αx indicates a value other than 1, the value of βx can be controlled to 0.5 to 1.0 by electrically changing the vibration amplitude. When αx=1, in the case where the value of βx lies within a range of 0.25 to 0.5, aliasing distortion suppressing conditions to be obtained in the present invention can be satisfied. Such a fact means that when the relative relation between the CCD and an image is controlled, an image having a less aliasing distortion can be obtained while the numerical aperture is equal to or larger than 1 in a false manner.

In FIG. 6, since reference symbols h₁ and r₁ correspond the case where the number of pixel sampling points is equal to four, the case corresponds to the foregoing embodiment of the present invention explained above with reference to FIGS. 2A and 2B.

Reference symbols h₃ and r₃ and h₄ and r₄ denote conditions that an aliasing distortion in which N=6 or N=8 is small and a resolution is high.

Accordingly, the conditions h₁, h₂, h₃, h₄, . . . at arbitrary N can be obtained by the following expressions.

βx 32 1/N (1)

1/N≦αx≦2/N (2)

The conditions r₁, r₂, r₃, r₄, . . . can be obtained by the following expressions.

αx=2/N (3)

1/(2N)≦βx≦1/N (4)

In the above-mentioned embodiment, the example using the triangular wave as a vibration waveform has been explained. Similar advantages can be obtained using a rectangular wave or a sine wave as a vibration waveform. When the frequency is the same, using, e.g., the triangular wave is useful to control the numerical aperture.

In each of the above-mentioned embodiments, the example where the device substrate is moved in the horizontal direction has been described. An effective resolution can also be raised in two directions of the horizontal and vertical directions by moving (the device substrate) in the vertical direction perpendicular to the horizontal direction.

The case where the position (vibration) of the device substrate is moved (vibrated) due to control by the position control section has been described as an example. In addition to the case, for example, a refractor is disposed in front of the imaging device to move the image points from the imaging optical system, so that the relative positions of the image points and the device substrate can be moved.

For the imaging apparatuses in the foregoing embodiments, the interline transfer type CCD as an imaging device has been described as an example. A dot-sequential reading system MOS type CCD can also be used. In this case, since light-sensitive portions have different transfer timings (light receiving timings), preferably, a mechanical shutter or the like is disposed, a blanking period is forcedly provided in the transfer timing, and the relative position of the imaging device is changed synchronously with the timing.

In addition to the case where motion pictures are successively provided, the present invention can also be applied to still picture imaging by an electronic still camera or the like.

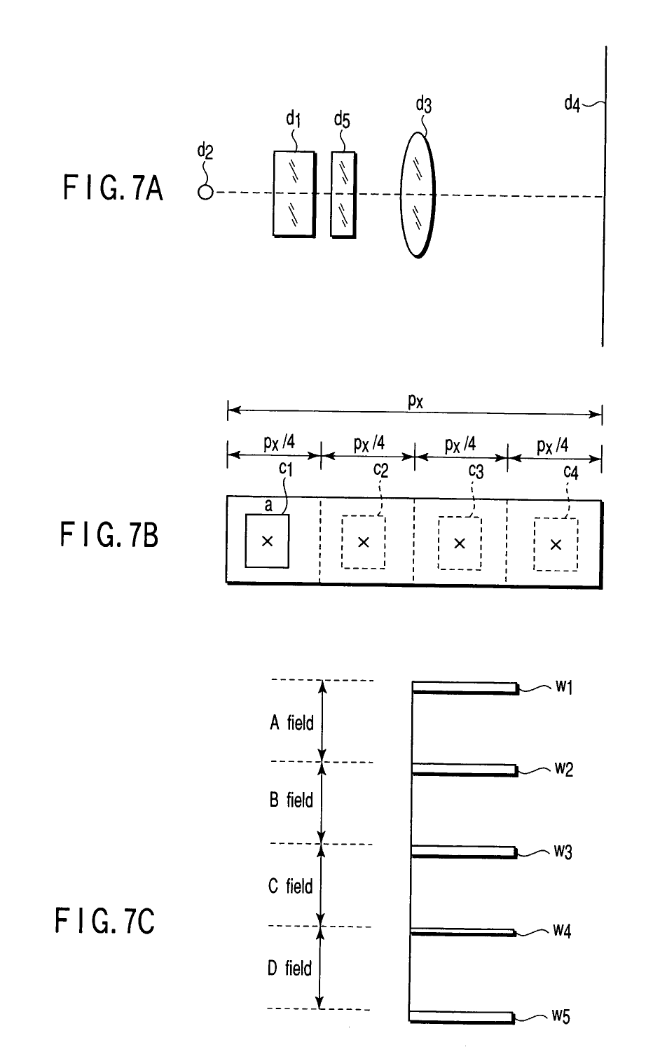

FIGS. 7A, 7B, and 7C show an example in which the above-mentioned present invention is applied to a display apparatus.

As shown in FIG. 7A, as a display apparatus, for example, a projection type display is considered. The display apparatus shown in FIG. 7A includes, for example, a light source d₂, a light transmission type liquid crystal display panel d₁ disposed in front of the light source d₂, a position control section d₅ including a refractor whose angle can be changed so that image points at which image light emitted from the liquid crystal display panel d₁ is formed as an image are moved relatively with respect to light emitting points (arbitrary pixels of the liquid crystal display panel d₁), and a screen d₄ disposed through a projection lens system d₃ on the front side thereof.

As a liquid crystal display panel d₁, an active matrix type liquid crystal display panel using, e.g., ferroelectric liquid crystal which is known for its high response speed can be used. Of course, as a display panel, in addition to the light transmission type panel, a reflection type panel can also be used. For example, a DMD (Digital Mirror Display, in which the angle of a mirror disposed in a pixel is changed, disclosed in, e.g., IEEE/ISSCC SLIDE SUPPLEMENT, pages 98 to 99), which can be operated at high speed, can also be used. In addition thereto, a self-luminescent type display panel such as an electroluminescent panel can also be used.

In the above-mentioned display apparatus, one frame is defined by four fields in a manner similar to the above-mentioned imaging apparatus. The image point is moved in the horizontal direction every field of each frame by the position control section d₅. In other words, for example, the liquid crystal display panel d₁ is moved in the horizontal direction for each blanking period between the four fields. Instead of moving the liquid crystal display panel d₁, the position of the projection optical system can also be controlled.

For example, when the liquid crystal display panel, namely, the light transmission type display device is used as an image light output section, it is desirable to prevent an adjacent image from being undesirably mixed for a period corresponding to the blanking period. For example, techniques such as blocking light from the light source d₂, allowing the display pixel to display a black image, and the like can be used. In a case where the image output section comprises, for example, a self-luminescent type display device, it is possible to easily prevent the foregoing mixing of the adjacent image by displaying black in the respective display pixels.

When it is assumed that the center of coordinates in the pixel is set to x, the center of aperture is located at x=−3Px/8 in the A field. Similarly, the center of aperture is located at x=Px/8 in the B field, it is located at x=3Px/8 in the C field, and it is located at x=−Px/8 in the D field.

When the operation is repeated, four image points can be formed in one physical pixel. Accordingly, an image having a resolution that is about four times as high as the physical pixels can be obtained.

Moreover, according to the embodiment shown in FIGS. 7A, 7B, and 7C, the spatial phase shifts 180° in the horizontal direction between the adjacent fields. Accordingly, the aliasing distortions of the adjacent fields cancel out each other, so that an image having less aliasing distortion and a higher resolution can be obtained.

In the embodiment shown in FIGS. 7A, 7B, and 7C, the aperture ratio on the screen d₄ is equal to 0.5. When it is assumed that a value obtained by dividing the area of a screen by a resolution is set to the display area per pixel, the aperture ratio on the screen represents the ratio of the display area per pixel to the area of one pixel is actually projected for the display area. Accordingly, the MTF at zero of the spatial frequencies (u*=0) and at the Nyquist frequency (u*=4) can be set to substantially zero [0], so that an image having less aliasing distortion and a higher resolution can be obtained.

As a method for moving the image points (image formed on the screen) on the screen d₄, needless to say, the liquid crystal display panel d₁ can be moved relatively to the screen d₄.

As mentioned above, the present invention can be applied to the imaging apparatus or display apparatus in which pixels are arranged one-dimensionally or two-dimensionally. The reading operation of signal charges of pixels or signal writing operation is simultaneously performed in all the pixels formed on the substrate for the blanking period between the fields. In the imaging apparatus, the pixel comprises a light-sensitive portion for converting incident light into signal charges and then accumulating the signal charges, and the signal charges of the pixel is read out by the reading section for reading out the signal charges. In the display apparatus, the pixel comprises a light-emitting portion in which light intensity is modulated by an electric signal, and the electric signal is written into the light-emitting portion.

For example, in the imaging apparatus in which one pixel (frame) includes four or more fields, an image having less aliasing distortion and a higher resolution can be obtained.

The imaging device or display apparatus is moved by a predetermined distance for the blanking period between the fields, whereby the aliasing distortion component is set to zero at zero in the spatial frequencies and at the Nyquist frequency determined by the pixel pitch. Consequently, an image having less aliasing distortion and a higher resolution can be provided or displayed.

The imaging device, substrate, or screen is moved in each field by a predetermined amount, whereby the shape of the aperture defined by the light-sensitive portion or light-emitting portion of the imaging device is changed. Consequently, an image having less aliasing distortion and a higher resolution can be obtained with high precision.

In the imaging apparatus and the display apparatus to which the present invention is applied, the resolution can be raised without increasing the number of pixels formed on the substrate. Accordingly, compared with the conventional apparatuses in which the number of pixels is increased to raise resolution, the sensitivity or luminance is not degraded due to the increase of the number of pixels. That is, dynamic range does not decrease.

As mentioned above, according to the imaging apparatus of the present invention, an image having less aliasing distortion and a higher resolution can be provided in the imaging apparatus or display apparatus. In the present apparatus, since the aliasing distortion can be set to zero at zero in the spatial frequencies and at the Nyquist frequency, an image having lower aliasing distortion and a higher resolution can be provided in a wide spatial frequency region.

The number of image sampling points can be increased without increasing the number of pixels formed on the substrate of the imaging apparatus. Accordingly, compared with the conventional method for raising the pixel density to realize a high resolution, an image having less aliasing distortion and a higher resolution can be obtained without deterioration of other image characteristics caused by raising the pixel density.

The above-mentioned embodiments of the present invention can be utilized as the following image processing method. For example, according to an image processing method which can provide or display an image in a resolution which is higher than the number of physical pixels provided by light-sensitive portions and display pixels, using an image processing section having at least one of an imaging apparatus including a plurality of light-sensitive portions and a display apparatus including a plurality of display pixels, and a position control section for displacing the relative positions of at least one pair of a pair of the light-sensitive portions of the image processing section and image points related to the respective light-sensitive portion and a pair of the display pixels of the image processing section and projection image points related to the respective display pixels, the relative positions can be displaced in at least one pair of the pair of light-sensitive portions of the image processing section and image points related to the respective light-sensitive portion and the pair of display pixels of the image processing section and projection image points related to the respective display pixels.

In this case, the respective display pixels are arranged at least one-dimensionally or two-dimensionally. Each display pixel includes an arbitrary number of fields that is equal to or larger than four and which is an even number. For the fields, the adjacent fields can be formed so that the respective spatial phases at the positions of the display pixels are shifted from each other by 180°. An effective aperture ratio of the light-sensitive portion is set so as to substantially minimize the aliasing distortion component at zero in spatial frequencies and at a Nyquist frequency.

Furthermore, the respective light-sensitive portions are arranged at least one-dimensionally or two-dimensionally. Each light-sensitive portion includes an arbitrary number of fields that is equal to or larger than four and which is an even number. The fields can be formed so that the spatial phase at the position of the light-sensitive portion shifts 180° between the adjacent fields. An effective image area ratio of a projection image point is set so as to substantially minimize the aliasing distortion component at zero in the spatial frequencies and at the Nyquist frequency.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An imaging apparatus comprising:
an imaging device having a plurality of light-sensitive portions arranged at least one-dimensionally or two-dimensionally, each light-sensitive portion including an arbitrary number of fields; and
a position control section which moves the relative positions of image points and the respective light-sensitive portions of the imaging device every field,
wherein an effective aperture ratio of the light-sensitive portion is set so as to substantially minimize an aliasing distortion component at zero of spatial frequencies and at a Nyquist frequency.

2. An imaging apparatus according to claim 1, wherein the one frame of the imaging device includes four or more fields.

3. An imaging apparatus according to claim 1, wherein the effective aperture ratio is determined on the basis of a physical aperture ratio of the light-sensitive portion.

4. An imaging apparatus according to claim 1, wherein,
the position control section vibrates the positions of the respective light-sensitive portions in each of the fields, and
the effective aperture ratio is determined on the basis of a physical aperture ratio of the light-sensitive portion and the vibration of the light-sensitive portion in each of the fields.

5. An imaging apparatus comprising:
an imaging device in which a plurality of light-sensitive portions are arranged at least one-dimensionally or two-dimensionally; and
a position control section which moves the relative positions of image points and the respective light-sensitive portions of the imaging device in a frame comprising four or more even-numbered fields every field,
wherein the fields are formed so that a spatial phase at the position of the light-sensitive portion shifts 180° between the adjacent fields.

6. An imaging apparatus according to claim 5, wherein an effective aperture ratio of the light-sensitive portion is set so as to substantially minimize an aliasing distortion component at zero of spatial frequencies and at a Nyquist frequency.

7. A display apparatus comprising:
a display panel having a plurality of display pixels arranged at least one-dimensionally or two-dimensionally, each display pixel including an arbitrary number of fields;
a screen onto which an image on the display panel is projected; and
a position control section which moves image points projected on the screen every field,
wherein an effective image area ratio on the screen is set so as to substantially minimize an aliasing distortion component at zero of spatial frequencies and at a Nyquist frequency.

8. A display apparatus according to claim 7, wherein the display apparatus includes the fields constituted in such a manner that one frame comprises four or more even-numbered fields.

9. A display apparatus according to claim 7, wherein the effective image area ratio is determined on the basis of a physical area ratio of the image on the screen.

10. A display apparatus according to claim 7,
wherein,
the position control section vibrates the positions of the image points in each of the fields, and
the effective area ratio is determined on the basis of the physical area of the image formed on the image points and the vibration in the field.

11. A display apparatus comprising:
a display panel having a plurality of display pixels arranged at least one-dimensionally or two-dimensionally, each display pixel including an arbitrary number of fields that is equal to or larger than four and is an even number;
a screen onto which an image on the display panel is projected; and
a position control section which moves image points projected on the screen every field,
wherein the fields are formed so that a spatial phase at the position of the display pixel shifts 180° between the adjacent fields.

12. A display apparatus according to claim 11, wherein an effective image area ratio of the image point is set so as to substantially minimize an aliasing distortion component at zero of spatial frequencies and at a Nyquist frequency.

13. An image processing method which can provide or display an image in a resolution, which is higher than the number of physical pixels provided by light-sensitive portions and display pixels, using an image processing section having at least one of an imaging apparatus including a plurality of light-sensitive portions and a display apparatus including a plurality of display pixels, and a position control section which displaces the relative positions of at least one pair of a pair of the light-sensitive portions of the image processing section and image points related to the respective light-sensitive portions, and a pair of the display pixels of the image processing section and projection image points related to the respective display pixels, said method comprising:
displacing the relative positions of at least one pair of the pair of the light-sensitive portions of the image processing section and the image points related to the respective light-sensitive portions and the pair of the display pixels of the image processing section and the projection image points related to the respective display pixels.

14. An image processing method according to claim 13,
wherein,
the display pixels are arranged at least one-dimensionally or two-dimensionally,
each display pixel includes an arbitrary number of fields which is equal to or larger than four and is an even number, and
the fields are formed so that a spatial phase at the position of the display pixel shifts 180° between the adjacent fields.

15. An image processing method according to claim 14, wherein an effective aperture ratio of the light-sensitive portion is set so as to substantially minimize an aliasing distortion component at zero of spatial frequencies and at a Nyquist frequency.

16. An image processing method according to claim 13,
wherein,
the light-sensitive portions are arranged at least one-dimensionally or two-dimensionally,
each light-sensitive portion includes an arbitrary number of fields which is equal to or larger than four and is an even number, and
the fields are formed so that a spatial phase at the position of the light-sensitive portion shifts 180° between the adjacent fields.

17. An image processing method according to claim 16, wherein an effective image area ratio of the projection image point is set so as to substantially minimize an aliasing distortion component at zero of spatial frequencies and at a Nyquist frequency.
